(19) United States
(12) Patent Application Publication
(10) Pub. No.: US 2015/0022922 A1
(43) Pub. Date: Jan. 22, 2015

(54) POWER SUPPLY CIRCUIT FOR POWER CONTROL CHIPS

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: KE-YOU HU, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/220,343

(22) Filed: Mar. 20, 2014

(30) Foreign Application Priority Data
Jul. 16, 2013 (CN) 2013102965599

(51) Int. Cl. H02H 9/04

(52) U.S. Cl. CPC H02H 9/041
USPC 361/56

(57) ABSTRACT

A power supply circuit for power control chips includes a voltage control circuit, a voltage output circuit and a feedback protect circuit. The voltage control circuit receives a first DC voltage, and outputs a voltage driving signal according to the first DC voltage. The voltage output circuit receives the voltage driving signal, and outputs a second DC voltage to a load according to the voltage driving signal. The feedback protect circuit receives the second DC voltage. The feedback protect circuit is turned on and connects the voltage control circuit to ground when the second DC voltage is over voltage. The voltage control circuit discharges to ground via the feedback protect circuit.

### BACKGROUND

1. Technical Field

The present disclosure relates to a power supply circuit for a power control chip.

2. Description of Related Art

Portable computers include power control chips to receive an input voltage. The power control chip drives a transformer outputting a +48 volts voltage. The +48 volts voltage is provided to a number of loads in the portable computer. A conventional power supply circuit for power control chips does not have over voltage protection functions. The power control chips may be damaged when the input voltage is over voltage.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a power supply circuit for power control chips.

FIG. 2 is a circuit diagram of the power supply circuit for power control chips of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

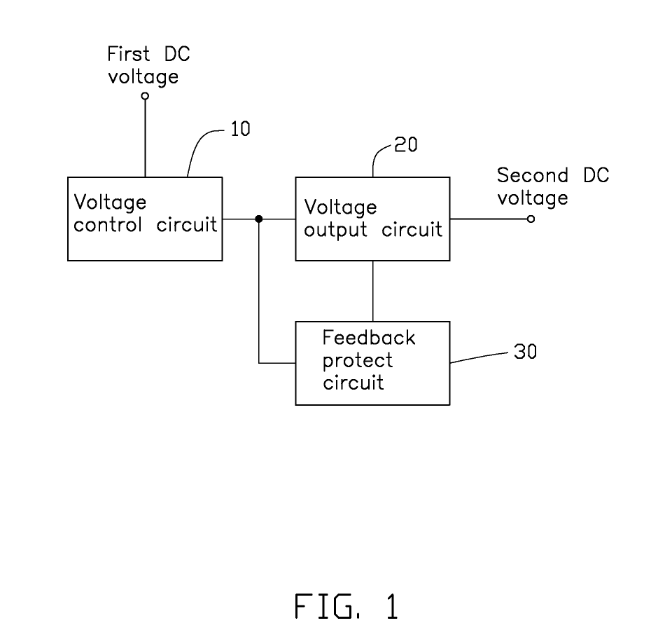

FIG. 1 shows a power supply circuit for power control chips of the embodiment. The power supply circuit for power control chips includes a voltage control circuit 10, a voltage output circuit 20 and a feedback protect circuit 30.

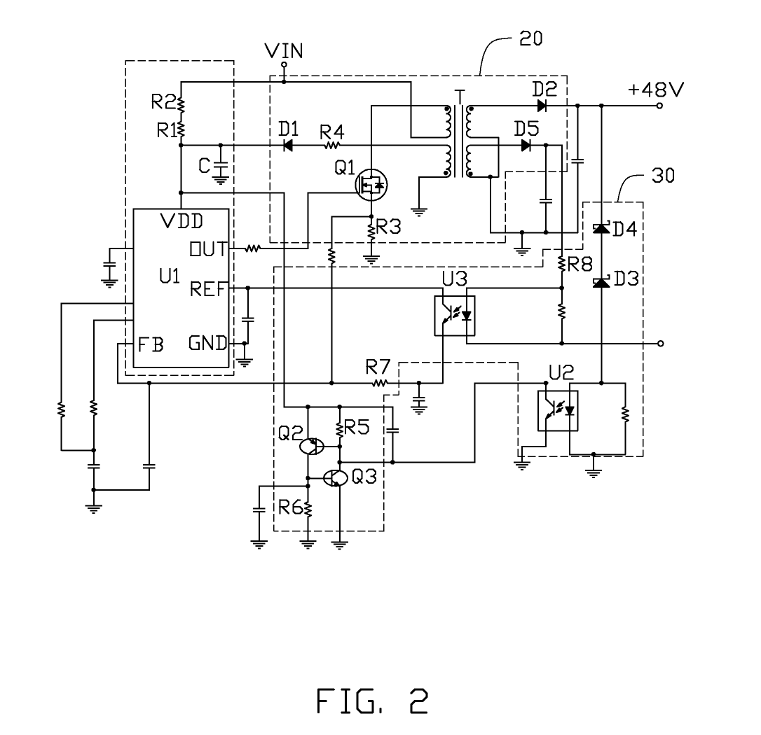

FIG. 2 shows the voltage control circuit 10 includes a power control chip U1, a first resistor R1, a second resistor R2 and a capacitor C. The power control chip U1 includes a power terminal VDD, a driving voltage output terminal OUT, a reference terminal REF and a feedback terminal FB. The power terminal VDD receives a first DC voltage via the first resistor R1 and the second resistor R2 connected in series. The power terminal VDD is grounded via the capacitor C.

The voltage output circuit 20 includes a MOSFET Q1 and a transformer T. The MOSFET Q1 includes a gate, a source and a drain. The transformer T includes a driving terminal, a first voltage input terminal, a second voltage input terminal, a first voltage output terminal and a second voltage output terminal. The gate of the MOSFET Q1 is electrically connected to the driving voltage output terminal OUT. The source of the MOSFET Q1 is grounded via a third resistor R3. The drain of the MOSFET Q1 is electrically connected to the driving terminal of the transformer T.

The first voltage input terminal of the transformer T receives the first DC voltage. The second voltage input terminal of the transformer T is electrically connected to a connecting point between the first resistor R1 and the capacitor C via a fourth resistor R4 and a first diode D1. The first voltage output terminal of the transformer T is electrically connected to an anode of a second diode D2. A cathode of the second diode D2 outputs a second DC voltage. In one embodiment, the MOSFET Q1 is a N channel MOSFET. The second DC voltage is +48 volts.

The feedback protect circuit 30 includes a first transistor Q2, a second transistor Q3, a first photocoupler U2, a second photocoupler U3, a third diode D3, a fourth diode D4, a fifth resistor R5 and a sixth resistor R6. Each of the first transistor Q2 and the second transistor Q3 includes a base, an emitter and a collector. The first photocoupler U2 includes a first light emitting unit and a first switch unit. The second photocoupler U3 includes a second light emitting unit and a second switch unit. In one embodiment, the first transistor Q2 is a pnp type transistor. The second transistor Q3 is a npn type transistor. The third diode D3 and the fourth diode D4 are Zener diodes.

The base of the first transistor Q2 is electrically connected to the power terminal VDD via the fifth resistor R5. The emitter of the first transistor Q2 is electrically connected to the power terminal VDD. The collector of the first transistor Q2 is grounded via the sixth resistor R6. The collector of the first transistor Q2 is electrically connected to the base of the second transistor Q3. The emitter of the second transistor Q3 is grounded. The collector of the second transistor Q3 is electrically connected to the base of the first transistor Q2.

Each of the first switch unit and the second switch unit includes a first terminal and a second terminal. Each of the first light emitting unit and the second light emitting unit includes an anode and a cathode. The first terminal of the first switch unit is electrically connected to the collector of the second transistor Q3. The second terminal of the first switch unit is grounded. The anode of the first light emitting unit is electrically connected to an anode of the third diode D3. The cathode of the first light emitting unit is grounded. A cathode of the third diode D3 is electrically connected to an anode of the fourth diode D4.

A cathode of the fourth diode D4 is electrically connected to the cathode of the second diode D2. The first terminal of the second switch unit is electrically connected to the reference terminal REF. The second terminal of the second switch unit is electrically connected to the feedback terminal FB via a seventh resistor R7. The anode of the second light emitting unit is electrically connected to a cathode of a fifth diode D5 via an eighth resistor R8. The cathode of the second light emitting unit receives a voltage feedback signal. An anode of the fifth diode D5 is electrically connected to the second voltage output terminal of the transformer T.

In use, the first DC voltage charges the capacitor C via the first resistor R1 and the second resistor R2. When the capacitor C is fully charged, the capacitor C provides the first DC voltage to the power control chip U1 via the power terminal VDD. The power control chip U1 is power on and outputs a voltage driving signal at the driving voltage output terminal OUT. The gate of the MOSFET Q1 receives the voltage driving signal. The MOSFET Q1 turns on. The drain of the MOSFET Q1 outputs the voltage driving signal to the driving terminal of the transformer T. The first voltage input terminal and the second voltage input terminal of the transformer T receives the first DC voltage. The transformer T outputs the +48 volts second DC voltage to a load (not shown) via the first voltage output terminal according to the voltage driving signal and the first DC voltage.

The load outputs the voltage feedback signal when the second DC voltage is abnormal. The cathode of the second light emitting unit receives the voltage feedback signal. The second light emitting unit turns on and emits light. The second switch unit detects the light from the second light emitting unit. The second switch unit turns on. The reference terminal REF and the feedback terminal FB are electrically connected. The power control chip U1 adjusts the voltage driving signal output by the driving voltage output terminal OUT. Therefore, the second DC voltage output by the first voltage output terminal of the transformer T is adjusted.

When the first DC voltage received by the power terminal VDD is over voltage, the second DC voltage output by the first voltage output terminal of the transformer T is greater than +48 volts. The third diode D3 and the fourth diode D4 are breakdown and turn on. The anode of the first light emitting unit receives the second DC voltage. The first light emitting unit turns on and emits light. The first switch unit detects the light from the first light emitting unit. The first switch unit turns on. The base of the first transistor Q2 is low voltage level. The first transistor Q2 turns on. The base of the second transistor Q3 receives the first DC voltage via the first transistor Q2. The second transistor Q3 turns on.

The capacitor C discharges to ground via the first transistor Q2 and the sixth resistor R6. The capacitor C discharges to ground via the fifth resistor R5 and the second transistor Q3. The capacitor C cannot provide the first DC voltage to the power control chip U1 via the power terminal VDD. The power control chip U1 is power off. Therefore, the power control chip U1 is protected from being damaged when the first DC voltage is over voltage.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A power supply circuit for power control chips, comprising:
a voltage control circuit configured for receiving a first DC voltage, and outputting a voltage driving signal according to the first DC voltage;
a voltage output circuit configured for receiving the voltage driving signal, and outputting a second DC voltage to a load according to the voltage driving signal; and
a feedback protect circuit configured for receiving the second DC voltage, wherein the feedback protect circuit is turned on and connects the voltage control circuit to ground when the second DC voltage is over voltage; the voltage control circuit discharges to ground via the feedback protect circuit.

2. The power supply circuit for power control chips of claim 1, wherein the load outputs a voltage feedback signal to the feedback protect circuit when the second DC voltage is less than a predetermined value; the feedback protect circuit triggers the voltage control circuit according to the voltage feedback signal; the voltage control circuit adjusts the voltage driving signal output to the voltage output circuit; and the second DC voltage output by the voltage output circuit is adjusted.

3. The power supply circuit for power control chips of claim 1, wherein the voltage control circuit comprises a power control chip, a first resistor and a capacitor; the power control chip comprises a power terminal; the power terminal receives the first DC voltage via the first resistor; and the power terminal is grounded via the capacitor.

4. The power supply circuit for power control chips of claim 3, wherein the power control chip further comprises a driving voltage output terminal; the voltage output circuit comprises a MOSFET and a transformer; the MOSFET comprises a gate, a source and a drain; the transformer comprises a driving terminal, a first voltage input terminal, a second voltage input terminal and a first voltage output terminal; the gate of the MOSFET is electrically connected to the driving voltage output terminal; the source of the MOSFET is grounded; the drain of the MOSFET is electrically connected to the driving terminal of the transformer; the first voltage input terminal of the transformer receives the first DC voltage; the second voltage input terminal of the transformer is electrically connected to a connecting point between the first resistor and the capacitor; and the first voltage output terminal of the transformer outputs the second DC voltage.

5. The power supply circuit for power control chips of claim 4, wherein the MOSFET is a N channel MOSFET; and the second DC voltage is +48 volts.

6. The power supply circuit for power control chips of claim 4, wherein the feedback protect circuit comprises a first transistor, a second transistor, a fifth resistor and a sixth resistor; each of the first transistor and the second transistor comprises a base, an emitter and a collector; the base of the first transistor is electrically connected to the power terminal via the fifth resistor; the emitter of the first transistor is electrically connected to the power terminal; the collector of the first transistor is grounded via the sixth resistor; the collector of the first transistor is electrically connected to the base of the second transistor; the emitter of the second transistor is grounded; and the collector of the second transistor is electrically connected to the base of the first transistor.

7. The power supply circuit for power control chips of claim 6, wherein the first transistor is a PNP type transistor; and the second transistor is a NPN type transistor.

8. The power supply circuit for power control chips of claim 6, wherein the power control chip further comprises a reference terminal and a feedback terminal; the transformer further comprises a second voltage output terminal; the feedback protect circuit further comprises a first photocoupler, a second photocoupler, a third diode and a fourth diode; the first photocoupler comprises a first light emitting unit and a first switch unit; the second photocoupler comprises a second light emitting unit and a second switch unit; each of the first switch unit and the second switch unit comprises a first terminal and a second terminal; each of the first light emitting unit and the second light emitting unit comprises an anode and a cathode.

9. The power supply circuit for power control chips of claim 8, wherein the first terminal of the first switch unit is electrically connected to the collector of the second transistor; the second terminal of the first switch unit is grounded; the anode of the first light emitting unit is electrically connected to an anode of the third diode; the cathode of the first light emitting unit is grounded; a cathode of the third diode is electrically connected to an anode of the fourth diode; a cathode of the fourth diode is electrically connected to the first voltage output terminal of the transformer; the first terminal of the second switch unit is electrically connected to the reference terminal; the second terminal of the second switch unit is electrically connected to the feedback terminal; the anode of the second light emitting unit is electrically connected to the second voltage output terminal of the transformer; and the cathode of the second light emitting unit receives the voltage feedback signal.

10. The power supply circuit for power control chips of claim 8, wherein the third diode and the fourth diode are Zener diodes.

11. A power supply circuit for power control chips, comprising:
a voltage control circuit configured for receiving a first DC voltage, and outputting a voltage driving signal according to the first DC voltage;
a voltage output circuit configured for receiving the voltage driving signal, and outputting a second DC voltage to a load according to the voltage driving signal; and
a feedback protect circuit configured for receiving the second DC voltage, wherein the feedback protect circuit turns on and connects the voltage control circuit to ground when the second DC voltage is over voltage; the voltage control circuit discharges to ground via the feedback protect circuit; the load outputs a voltage feedback signal to the feedback protect circuit when the second DC voltage is less than a predetermined value; the feedback protect circuit triggers the voltage control circuit according to the voltage feedback signal; the voltage control circuit adjusts the voltage driving signal output to the voltage output circuit; and the second DC voltage output by the voltage output circuit is adjusted.

12. The power supply circuit for power control chips of claim 11, wherein the voltage control circuit comprises a power control chip, a first resistor and a capacitor; the power control chip comprises a power terminal; the power terminal receives the first DC voltage via the first resistor; and the power terminal is grounded via the capacitor.

13. The power supply circuit for power control chips of claim 12, wherein the power control chip further comprises a driving voltage output terminal; the voltage output circuit comprises a MOSFET and a transformer; the MOSFET comprises a gate, a source and a drain; the transformer comprises a driving terminal, a first voltage input terminal, a second voltage input terminal and a first voltage output terminal; the gate of the MOSFET is electrically connected to the driving voltage output terminal; the source of the MOSFET is grounded; the drain of the MOSFET is electrically connected to the driving terminal of the transformer; the first voltage input terminal of the transformer receives the first DC voltage; the second voltage input terminal of the transformer is electrically connected to a connecting point between the first resistor and the capacitor; and the first voltage output terminal of the transformer outputs the second DC voltage.

14. The power supply circuit for power control chips of claim 13, wherein the MOSFET is a N channel MOSFET; and the second DC voltage is +48 volts.

15. The power supply circuit for power control chips of claim 13, wherein the feedback protect circuit comprises a first transistor, a second transistor, a fifth resistor and a sixth resistor; each of the first transistor and the second transistor comprises a base, an emitter and a collector; the base of the first transistor is electrically connected to the power terminal via the fifth resistor; the emitter of the first transistor is electrically connected to the power terminal; the collector of the first transistor is grounded via the sixth resistor; the collector of the first transistor is electrically connected to the base of the second transistor; the emitter of the second transistor is grounded; and the collector of the second transistor is electrically connected to the base of the first transistor.

16. The power supply circuit for power control chips of claim 15, wherein the first transistor is a PNP type transistor; and the second transistor is a NPN type transistor.

17. The power supply circuit for power control chips of claim 15, wherein the power control chip further comprises a reference terminal and a feedback terminal; the transformer further comprises a second voltage output terminal; the feedback protect circuit further comprises a first photocoupler, a second photocoupler, a third diode and a fourth diode; the first photocoupler comprises a first light emitting unit and a first switch unit; the second photocoupler comprises a second light emitting unit and a second switch unit; each of the first switch unit and the second switch unit comprises a first terminal and a second terminal; each of the first light emitting unit and the second light emitting unit comprises an anode and a cathode.

18. The power supply circuit for power control chips of claim 17, wherein the first terminal of the first switch unit is electrically connected to the collector of the second transistor; the second terminal of the first switch unit is grounded; the anode of the first light emitting unit is electrically connected to an anode of the third diode; the cathode of the first light emitting unit is grounded; a cathode of the third diode is electrically connected to an anode of the fourth diode; a cathode of the fourth diode is electrically connected to the first voltage output terminal of the transformer; the first terminal of the second switch unit is electrically connected to the reference terminal; the second terminal of the second switch unit is electrically connected to the feedback terminal; the anode of the second light emitting unit is electrically connected to the second voltage output terminal of the transformer; and the cathode of the second light emitting unit receives the voltage feedback signal.

19. The power supply circuit for power control chips of claim 17, wherein the third diode and the fourth diode are Zener diodes.
